(19) United States
(12) Patent Application Publication
(10) Pub. No.: US 2023/0326679 A1
(43) Pub. Date: Oct. 12, 2023

(54) METHOD FOR MANUFACTURING CERAMIC ELECTRONIC COMPONENT

(71) Applicant: Murata Manufacturing Co., Ltd., Nagaokakyo-shi (JP)

(72) Inventor: Yuta TANAKA, Nagaokakyo-shi (JP)

(21) Appl. No.: 18/210,137

(22) Filed: Jun. 15, 2023

Related U.S. Application Data
(63) Continuation of application No. PCT/JP2021/042702, filed on Nov. 20, 2021.

(30) Foreign Application Priority Data
Feb. 22, 2021 (JP) 2021-026199

(51) Int. Cl. H01G 4/30; H01G 13/00

(52) U.S. Cl. CPC H01G 4/30; H01G 13/00

(57) ABSTRACT

A method for manufacturing a ceramic electronic component includes a ceramic chip element assembly production step of producing ceramic chip element assemblies, a jig preparation step of preparing a jig with chip storing portions including a bottom portion to support a ceramic chip element assembly from below and an open-top side wall portion, a ceramic chip element assembly storing step of storing the ceramic chip element assemblies in the chip storing portions in a one-to-one correspondence, a ceramic chip element assembly working step of working the ceramic chip element assemblies stored in the chip storing portions, and a ceramic chip element assembly removal step of removing the ceramic chip element assemblies from the chip storing portions.

### CROSS REFERENCE TO RELATED APPLICATIONS

This application claims the benefit of priority to Japanese Patent Application No. 2021-026199 filed on Feb. 22, 2021 and is a Continuation Application of PCT Application No. PCT/JP2021/042702 filed on Nov. 20, 2021. The entire contents of each application are hereby incorporated herein by reference.

### BACKGROUND OF THE INVENTION

### 1. Field of the Invention

The present invention relates to a method for manufacturing a ceramic electronic component.

Ceramic electronic components which are objects of production according to preferred embodiments of the present invention include multilayer-type ceramic electronic components, such as multilayer ceramic capacitors, multilayer ceramic inductors, multilayer ceramic thermistors, multilayer ceramic LC components, and multilayer ceramic substrates. In addition, ceramic electronic components which are objects of production according to preferred embodiments of the present invention include non-multilayer-type ceramic electronic components, such as ceramic resonators, ceramic filters, ceramic resistors, ceramic thermistors, and ceramic substrates.

### 2. Description of the Related Art

Japanese Unexamined Patent Application Publication No. 11-233364 discloses a method for manufacturing a multilayer ceramic capacitor (ceramic electronic component).

The method for manufacturing a multilayer ceramic capacitor according to Japanese Unexamined Patent Application Publication No. 11-233364 includes a step of producing a molded body in which a ceramic green sheet and an inner electrode layer are stacked and a step of obtaining a sintered body by firing the molded body.

Of these steps, regarding the step of firing the molded body, in general, a method in which a plurality of molded bodies are placed on a ceramic sagger, and firing is performed in a firing furnace is widely adopted.

### SUMMARY OF THE INVENTION

Regarding the step of firing the molded body (not limited to the multilayer-type molded body and including a so-called bulk-type molded body) in the above-described method for manufacturing a ceramic electronic component in the related art, there is a problem that variations in the characteristics (electrical characteristics and the like), the shapes, and the like occur between the resulting sintered bodies. That is, there is a problem that variations in the characteristics, the shapes, and the like occur between the resulting sintered bodies in accordance with the position of placement on the sagger, the state of placement, and the like and, as a result, variations in the characteristics, the shapes, and the like occur between the produced ceramic electronic components.

In addition, there is a problem that defective products readily occur due to, for example, an occurrence of mutual adhesion between a plurality of sintered bodies after being subjected to a firing step. That is, there is a problem that the productivity of the ceramic electronic component deteriorates.

Regarding not only the firing step but also other working steps, variations in the characteristics, the shapes, and the like of the produced ceramic electronic components may occur due to, for example, the structure of a jig used.

A method for manufacturing a ceramic electronic component according to a preferred embodiment of the present invention includes a ceramic chip element assembly production step of producing a plurality of ceramic chip element assemblies, a jig preparation step of preparing a jig including a plurality of chip storing portions including a bottom portion to support a ceramic chip element assembly from below and an open-top side wall portion, a ceramic chip element assembly storing step of storing the ceramic chip element assemblies into the chip storing portions of the jig in a one-to-one correspondence, a ceramic chip element assembly working step of working the ceramic chip element assemblies stored in the chip storing portions of the jig, and a ceramic chip element assembly removal step of removing the ceramic chip element assemblies from the chip storing portions of the jig.

According to the methods for manufacturing ceramic electronic components of preferred embodiments of the present invention, variations in the quality (characteristics, shape, and the like) of the ceramic electronic component can be reduced or prevented from occurring.

In addition, according to a method for manufacturing a ceramic electronic component of a preferred embodiment of the present invention, mutual adhesion between a plurality of ceramic chip element assemblies after being subjected to a ceramic chip element assembly working step can be reduced or prevented from occurring. Therefore, the productivity of the ceramic electronic components can be improved.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a sectional view illustrating a multilayer ceramic capacitor 100.

Each of FIGS. 2A and 2B are explanatory diagrams illustrating a step in an example of a method for manufacturing the multilayer ceramic capacitor 100.

FIGS. 3C to 3F follow FIG. 2B, and each of these is an explanatory diagram illustrating a step in an example of a method for manufacturing the multilayer ceramic capacitor 100 or a multilayer ceramic capacitor during production.

FIGS. 4G and 4H follow FIG. 3F, and each of these is an explanatory diagram illustrating a step in an example of a method for manufacturing the multilayer ceramic capacitor 100.

FIGS. 51 and 5J follow FIG. 4H, and each of these is an explanatory diagram illustrating a multilayer ceramic capacitor during production in an example of a method for manufacturing the multilayer ceramic capacitor 100.

FIG. 6 is a plan view illustrating a jig 1000.

Each of FIGS. 7A to 7D is a sectional view illustrating the jig 1000.

FIG. 8A is a plan view illustrating a key portion of the jig 1000. Each of FIGS. 8B and 8C is a sectional view illustrating a key portion of the jig 1000.

FIG. 9A is an explanatory diagram illustrating the diameter dimension P of an inscribed circle of a side wall portion 8c of a chip storing portion 8 in the jig 1000. FIG. 9B is an explanatory diagram illustrating the depth dimension Q of the chip storing portion 8 in the jig 1000.

Each of FIGS. 10A and 10B is an explanatory diagram illustrating a jig 1000 according to Modified Example 2.

FIG. 11 is an explanatory diagram illustrating a jig 1000 according to Modified Example 3.

Each of FIGS. 12A and 12B is a sectional view illustrating a jig 1000 according to Modified Example 4.

FIG. 13A is a plan view illustrating a jig 2000. FIG. 13B is a sectional view illustrating the jig 2000.

### DETAILED DESCRIPTION OF THE PREFERRED EMBODIMENTS

Preferred embodiments according to the present invention will be described below with reference to the drawings.

In this regard, the preferred embodiments illustrate exemplary forms of realization of the present invention, and the present invention is not limited to the contents of the preferred embodiments. In addition, the contents described in different preferred embodiments may be performed in combination, and the contents of the performance in such an instance are included within the scope of the present invention. In this regard, the drawings are intended to facilitate understanding of the specification and may be schematically drawn. The dimensional ratio of elements or features in the drawing is not limited to being in accord with the dimensional ratio thereof described in the specification. Further, the elements or features described in the specification may be omitted from the drawing, or the number of the elements or features may be decreased in the drawing.

### First Preferred Embodiment

In the first preferred embodiment, a multilayer ceramic capacitor 100 is produced by using a jig 1000 described later. In this regard, the multilayer ceramic electronic component to be produced is not limited to the multilayer ceramic capacitor and may be other multilayer-type ceramic electronic components, such as multilayer ceramic inductors, multilayer ceramic thermistors, multilayer ceramic LC components, and multilayer ceramic substrates, or non-multilayer-type ceramic electronic components, such as ceramic resonators, ceramic filters, ceramic resistors, ceramic thermistors, and ceramic substrates. In addition, the jig used for production is not limited to the jig 1000, and other jigs may be used.

### Multilayer Ceramic Capacitor 100

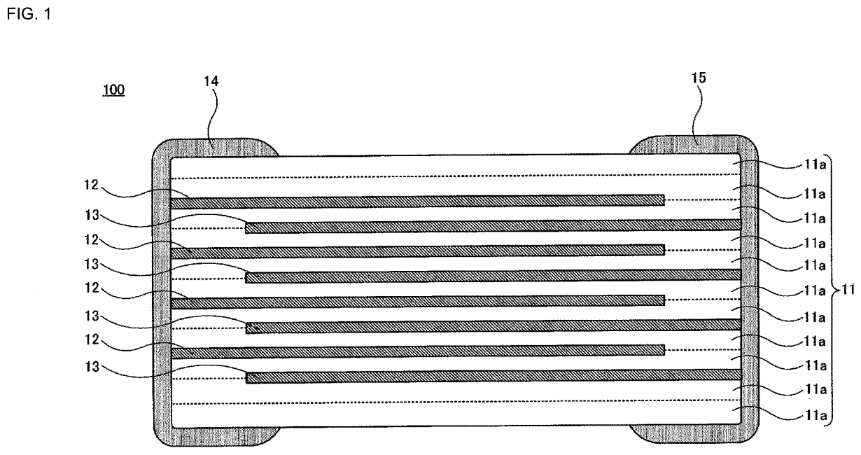

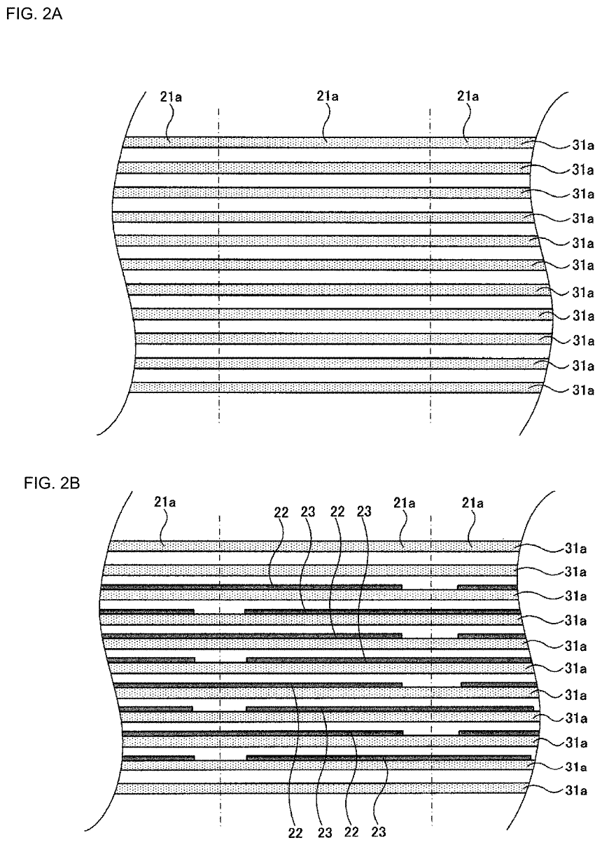

FIG. 1 illustrates the multilayer ceramic capacitor 100 produced in the first preferred embodiment. In this regard, FIG. 1 is a sectional view illustrating the multilayer ceramic capacitor 100.

The multilayer ceramic capacitor 100 is provided with a ceramic chip element assembly 11 having a rectangular or substantially rectangular parallelepiped shape. The ceramic chip element assembly 11 includes a multilayer body in which a plurality of non-conductor layers 11a and a plurality of first inner electrode layers 12, and a plurality of second inner electrode layers 13 are stacked.

The material for forming the ceramic chip element assembly 11 (non-conductor layer 11a) is optional. For example, a dielectric ceramic containing BaTiO₃ as a main component can be used. However, a dielectric ceramic containing other material, such as CaTiO₃, SrTiO₃, or CaZrO₃, instead of BaTiO₃ as a main component may also be used.

The thickness of the non-conductor layer 11a is optional and may be set to be, for example, about 0.3 μm to about 2.0 μm in the capacitance-formation effective region in which the first inner electrode layer 12 and the second inner electrode layer 13 are formed.

The number of the non-conductor layers 11a is optional and may be set to be, for example, about 1 layer to 6,000 layers in the capacitance-formation effective region in which the first inner electrode layer 12 and the second inner electrode layer 13 are formed.

At both ends of the ceramic chip element assembly 11 in the stacking direction, neither the first inner electrode layer 12 nor the second inner electrode layer 13 is formed, and outer layers (protective layers) including only the non-conductor layer 11a are provided. The thickness of the non-conductor layer 11a in the outer layer region may differ from the thickness of the non-conductor layer 11a in the capacitance-formation effective region in which the first inner electrode layer 12 and the second inner electrode layer 13 are formed. In addition, the material for forming the non-conductor layer 11a in the outer layer region may differ from the material for forming the non-conductor layer 11a in the effective region.

The first inner electrode layer 12 is extended to one end surface (an optional outer surface orthogonal to the stacking direction) of the ceramic chip element assembly 11. The second inner electrode layer 13 is extended to the other end surface (an outer surface opposite to the one end surface) of the ceramic chip element assembly 11. In this regard, the first inner electrode layer 12 and the second inner electrode layer 13 are alternately stacked on top of each other in principle.

The material for forming the main component (metal component) of the first inner electrode layer 12 and the second inner electrode layer 13 is optional. For example, Ni, Cu, Ag, Pd, and Au can be used. In this regard, Ni, Cu, Ag, Pd, Au, or the like may be an alloy with other metals. The first inner electrode layer 12 and the second inner electrode layer 13 may contain other components such as ceramic in addition to the metal component.

The thickness of the first inner electrode layer 12 and the thickness of the second inner electrode layer 13 are optional and may be set to be, for example, about 0.3 μm to about 1.5 μm.

A first outer electrode 14 is formed on one end surface of the outer surface of the ceramic chip element assembly 11. A second outer electrode 15 is formed on the other end surface of the outer surface of the ceramic chip element assembly 11. The first inner electrode layer 12 is electrically coupled to the first outer electrode 14. The second inner electrode layer 13 is electrically coupled to the second outer electrode 15.

The structures of the first outer electrode 14 and the second outer electrode 15 are optional. It is also preferable that one layer or a plurality of layers of plating electrode layers be formed on the outer surfaces of the first outer electrode 14 and the second outer electrode 15. In this regard, in FIG. 1, the plating electrode layer is not illustrated in the drawing.

The material for forming the main component (metal component) of the first outer electrode 14 and the second outer electrode 15 is optional. For example, Ni, Cu, Ag, Pd, and Au can be used. In this regard, Ni, Cu, Ag, Pd, Au, or the like may be an alloy with other metals. An underlying electrode layer may contain other components such as ceramic in addition to the metal component.

The type and the number of the plating electrode layers are also optional. For example, a Cu plating layer, a Ni plating layer, a Sn plating layer, and the like may be formed.

### An Example of Method for Manufacturing Multilayer Ceramic Capacitor 100

A method for manufacturing the multilayer ceramic capacitor 100 according to the present preferred embodiment will be described below with reference to FIG. 2A to FIG. 5J. In this regard, a jig 1000 described later is used in the method for manufacturing the multilayer ceramic capacitor 100 according to the present preferred embodiment.

### (1) Production of Ceramic Slurry

A dielectric ceramic powder, a binder resin, a solvent, and the like are prepared, and a ceramic slurry is produced by wet-mixing these materials, although not illustrated in the drawing.

### (2) Production of Ceramic Green Sheet

A ceramic green sheet 21a for producing the non-conductor layer 11a illustrated in FIG. 2A is produced. To produce a plurality of ceramic electronic components in one operation, it is preferable that the ceramic green sheet 21a be prepared as a mother ceramic green sheet 31a including a plurality of ceramic green sheets 21a. FIG. 2A illustrates the mother ceramic green sheet 31a, and the ceramic green sheet 21a serving as a ceramic electronic component is demarcated by alternate long and short lines.

Initially, a carrier film (not illustrated in the drawing) is prepared. Subsequently, a ceramic slurry in the shape of a sheet is applied to the carrier film by using a die coater, gravure coater, a MICROGRAVURE coater, or the like, and drying is performed so as to produce the ceramic green sheet 21a. The resulting ceramic green sheet 21a is appropriately peeled and removed from the carrier film in a later step.

### (3) Production of Inner Electrode Paste/Outer Electrode Paste

A metal powder, a binder resin, a solvent, and the like are prepared, and an inner electrode paste and an outer electrode paste are produced by wet-mixing these materials, although not illustrated in the drawing. The inner electrode paste and the outer electrode paste may differ from each other in the material, the material ratio, the viscosity, and the like.

### (4) Application of Inner Electrode Paste

As illustrated in FIG. 2B, the main surface of the predetermined ceramic green sheet 21a is coated with an inner electrode paste 22 for forming the first inner electrode layer 12 or an inner electrode paste 23 for forming the second inner electrode layer 13 with respective predetermined pattern shapes. In this regard, the ceramic green sheet 21a serving as the outer layer is not coated with the inner electrode paste. The inner electrode paste may be applied by, for example, screen printing, ink jet printing, intaglio printing, or relief printing. Drying treatment is performed after the inner electrode pastes 22 and 23 are applied.

### (5) Production of Mother Ceramic Green Sheet Multilayer Body

Initially, the mother ceramic green sheets 31a illustrated in FIG. 2B are stacked in a predetermined order. The mother ceramic green sheets 31a include the ceramic green sheet 21a coated with the inner electrode paste 22, the ceramic green sheet 21a coated with the inner electrode paste 23, and ceramic green sheet 21a not coated with the inner electrode paste. In this regard, at this time, the ceramic green sheet 21a has been peeled and removed from the carrier film.

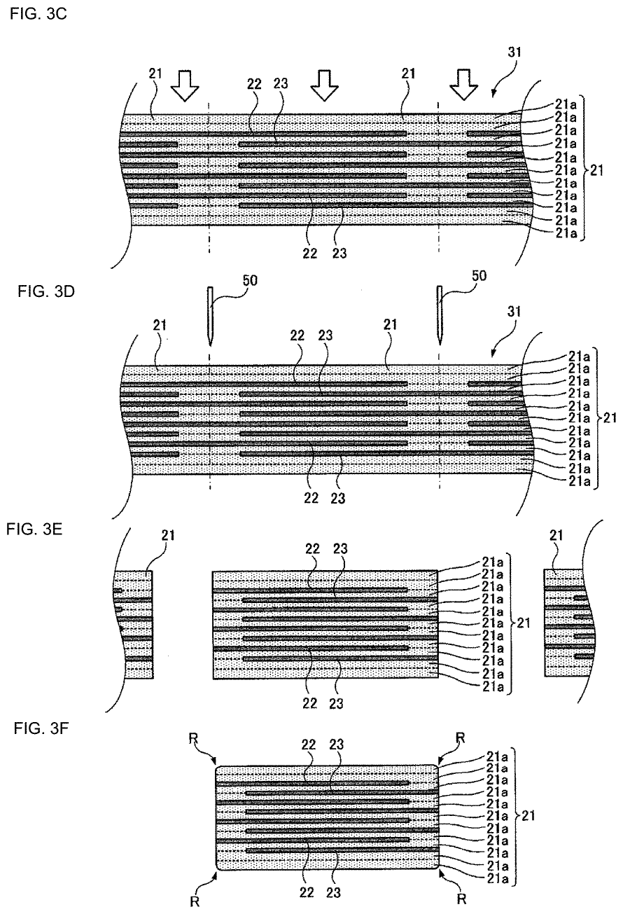

Subsequently, as illustrated in FIG. 3C, the plurality of stacked mother ceramic green sheets 31a are integrated by pressure bonding to produce a mother ceramic green sheet multilayer body 31. The mother ceramic green sheet multilayer body 31 includes a plurality of unfired ceramic chip element assemblies 21.

### (6) Cutting of Mother Ceramic Green Sheet Multilayer Body

As illustrated in FIG. 3D, the mother ceramic green sheet multilayer body 31 is cut by using, for example, a cutting blade 50 to obtain a plurality of individual unfired ceramic chip element assemblies 21, as illustrated in FIG. 3E.

### (7) Barrel Polishing

As the situation demands, the unfired ceramic chip element assembly 21 is subjected to barrel polishing so as to provide a corner portion or a ridge line of the unfired ceramic chip element assembly 21 with roundness R, as illustrated in FIG. 3F.

### (8) Jig Preparation Step

The jig 1000 is prepared. More specifically, the jig 1000 provided with a plurality of chip storing portions 8 having a bottom portion to support the unfired ceramic chip element assembly 21 from below and an open-top side wall portion is prepared. Since the jig 1000 will be summarized later, explanations thereof are not provided herein.

### (9) Ceramic Chip Element Assembly Storing Step

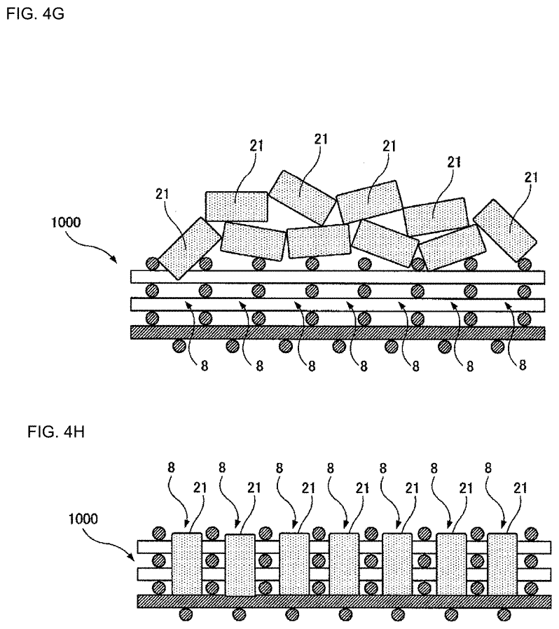

Thereafter, as illustrated in FIG. 4G, a plurality of unfired ceramic chip element assemblies 21 are placed at random positions and in random states on the upper surface of the jig 1000. Subsequently, the jig 1000 is vibrated so as to store the unfired ceramic chip element assemblies into the chip storing portions 8 of the jig 1000 in a one-to-one correspondence, as illustrated in FIG. 4H. In this regard, it is also preferable to remove excess unfired ceramic chip element assemblies 21 from the jig 1000 by a method in which, for example, vibration is further applied, the jig 1000 is inclined, or the jig 1000 is inclined while vibration is applied.

In this regard, the unfired ceramic chip element assembly 21 may be stored into the chip storing portion 8 by inclining the jig 1000 instead of applying vibration to the jig 1000. Alternatively, the unfired ceramic chip element assembly 21 may be directly stored into the chip storing portion 8 by using an automatic machine or the like without placing the unfired ceramic chip element assembly 21 on the upper surface of the jig 1000.

### (10) Firing (One of Ceramic Chip Element Assembly Working Step)

As illustrated in FIG. 4H, the unfired ceramic chip element assembly 21 in the state of being stored in the chip storing portion 8 in a one-to-one correspondence is heated and fired with the jig 1000. In this regard, when a resin component is contained in the ceramic green sheet 21a, a degreasing step of decreasing or removing the resin component by heating or the like may be performed before the firing step.

Firing is performed at a predetermined temperature profile. The ceramic green sheet 21a is converted to the non-conductor layer 11a, the inner electrode paste 22 is converted to the first inner electrode layer 12, and the inner electrode paste 23 is converted to the second inner electrode layer 13 due to firing. Therefore, the unfired ceramic chip element assembly 21 is converted to a fired ceramic chip element assembly 11.

### (11) Removal of Ceramic Chip Element Assembly

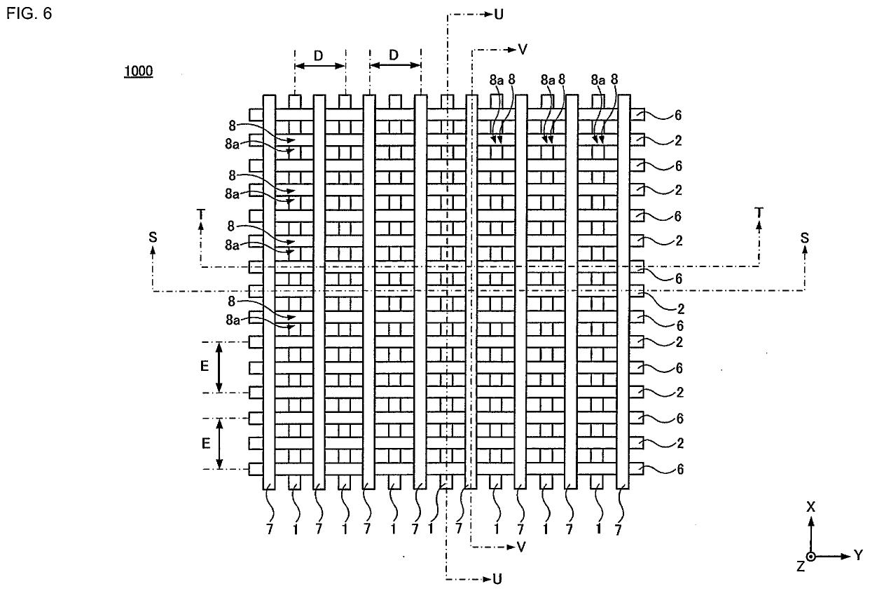

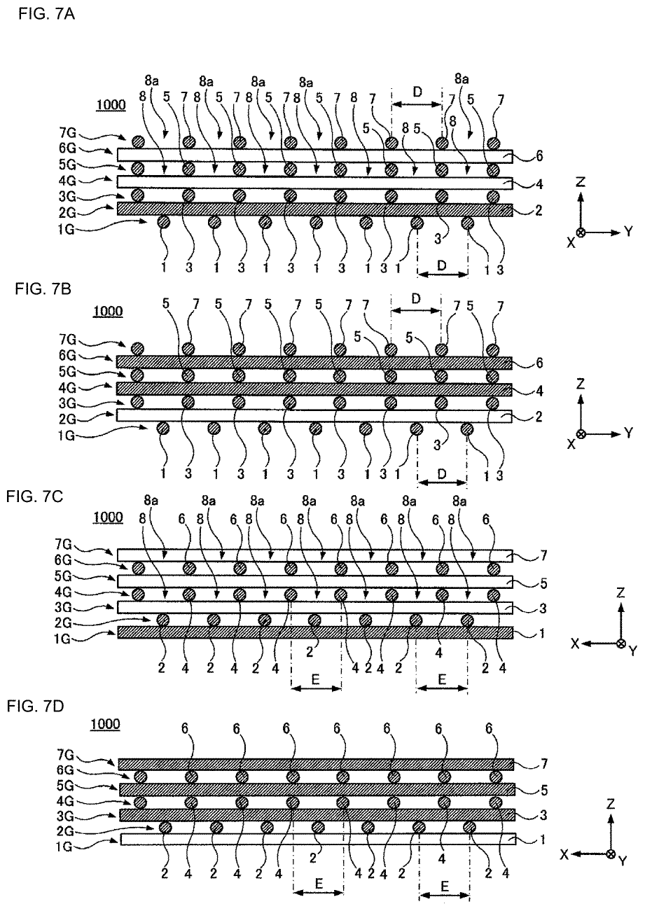

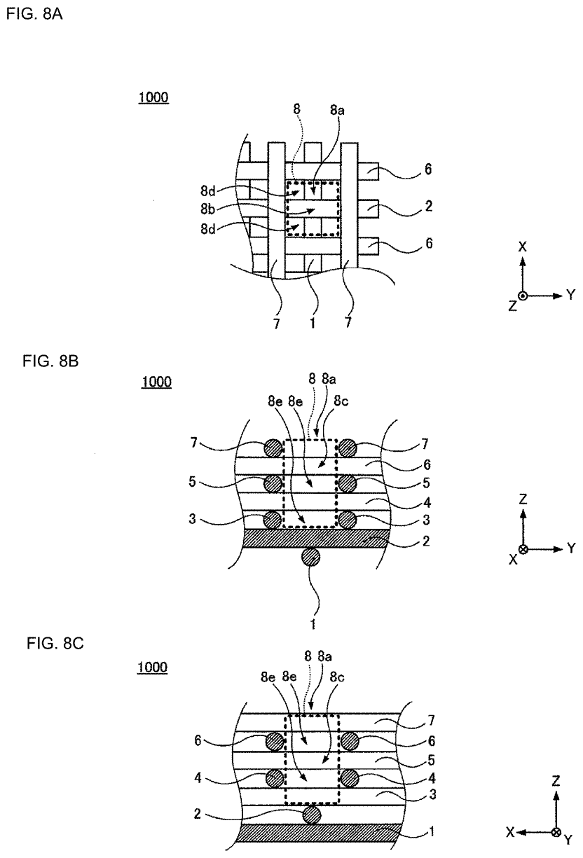

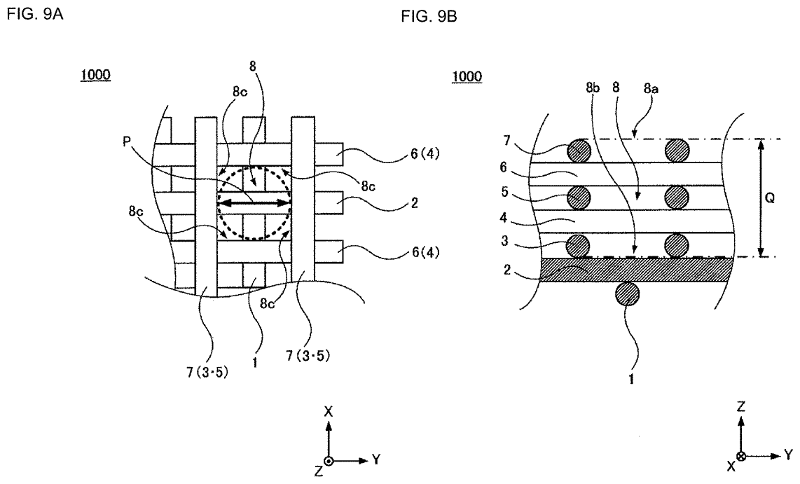

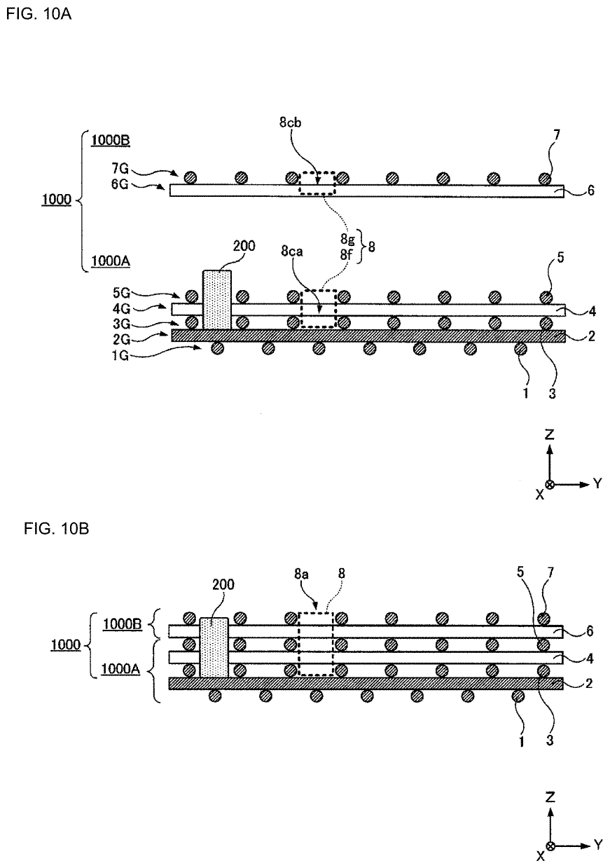

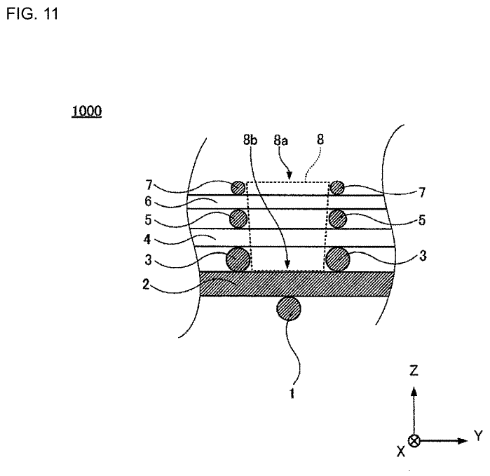

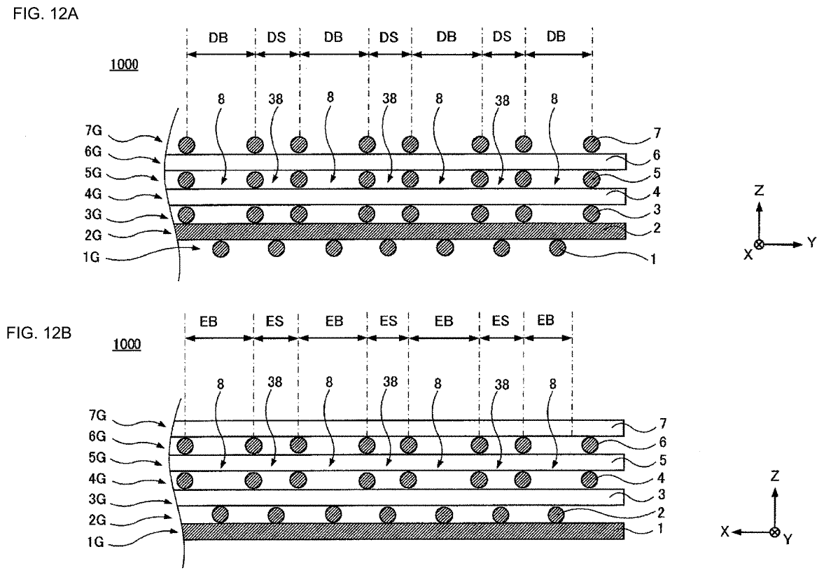

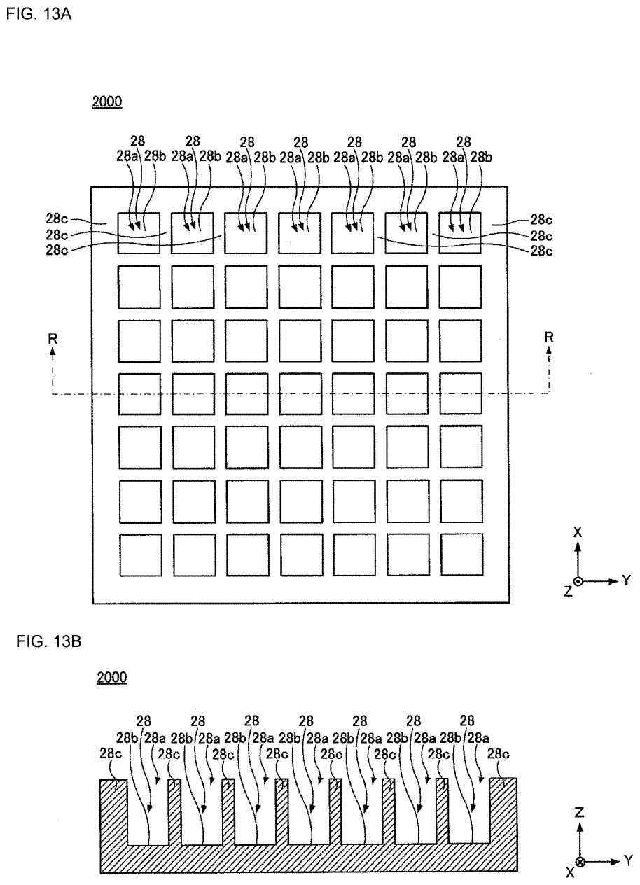

As illustrated in FIG. 51, the fired ceramic chip element assembly 11 is removed from the chip storing portion 8 in the jig 1000.

### (12) Formation of Outer Electrode

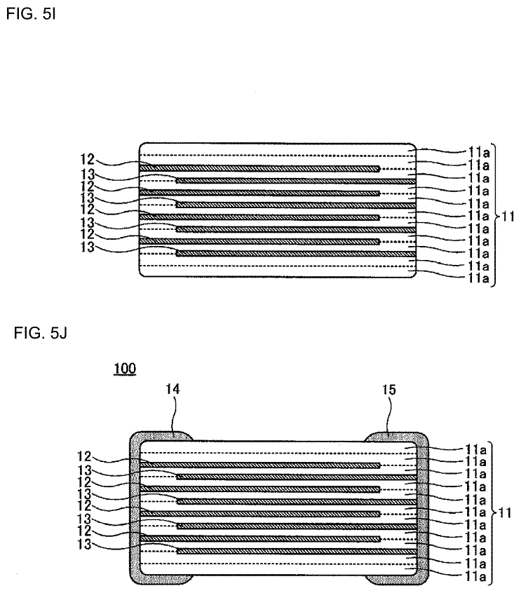

As illustrated in FIG. 5J, the first electrode 14 is formed on one end portion of the ceramic chip element assembly 11, and the second outer electrode 15 is formed on the other end portion.

Specifically, both end portions of the outer surface of the ceramic chip element assembly 11 are coated with the outer electrode paste. The ceramic chip element assembly 11 coated with the outer electrode paste is heated to bake the outer electrode paste onto the outer surface of the ceramic chip element assembly 11 so as to form the first electrode 14 and the second electrode 15.

### (13) Plating

Thereafter, the outer surfaces of the first electrode 14 and the second electrode 15 are subjected to, for example, electrolytic plating to form plating layers including one layer or a plurality of layers.

Consequently, the multilayer ceramic capacitor 100 is completed.

### Modified Example 1 of Method for Manufacturing Multilayer Ceramic Capacitor 100

In the above-described method for manufacturing the multilayer ceramic capacitor 100, the plurality of mother ceramic green sheets 31a are integrated by stacking and pressure bonding to form the mother ceramic green sheet multilayer body 31, and thereafter the mother ceramic green sheet multilayer body 31 is cut into individual unfired ceramic chip element assemblies 21. In Modified Example 1, this method is changed.

Specifically, in Modified Example 1, initially, the mother ceramic green sheet 31a including the plurality of ceramic green sheets 21a is cut into individual ceramic green sheets 21a. Subsequently, the plurality of ceramic green sheets 21a are integrated by stacking and pressure bonding so as to produce the unfired ceramic chip element assembly 21.

As described above, regarding the steps of producing the unfired ceramic chip element assembly 21, the order of the steps may be changed.

### Modified Example 2 of Method for Manufacturing Multilayer Ceramic Capacitor 100

In the above-described method for manufacturing the multilayer ceramic capacitor 100, after the fired ceramic chip element assembly 11 is obtained by firing the unfired ceramic chip element assembly 21, the first electrode 14 and the second electrode 15 are formed by applying and baking the outer electrode paste onto both ends of the ceramic chip element assembly 11. In Modified Example 2, this method is changed.

Specifically, in Modified Example 2, initially, the outer electrode paste is applied to both ends of the unfired ceramic chip element assembly 21 before the firing step. Thereafter, in the firing step, the first electrode 14 and the second electrode 15 are formed on the respective ends of the ceramic chip element assembly 11 by baking the outer electrode paste.

As described above, the method for forming the first electrode 14 and the second electrode 15 may be changed.

### Jig 1000

Next, the jig 1000 used in the above-described method for manufacturing the multilayer ceramic capacitor 100 will be described.

FIG. 6, FIGS. 7A to 7D, FIGS. 8A to 8C illustrate the jig 1000. In this regard, FIG. 6 is a plan view illustrating the jig 1000. Each of FIGS. 7A to 7D is a sectional view illustrating the jig 1000. FIG. 7A illustrates a portion indicated by alternate long and short lines arrow S-S in FIG. 6. FIG. 7B illustrates a portion indicated by alternate long and short lines arrow T-T in FIG. 6. FIG. 7C illustrates a portion indicated by alternate long and short lines arrow U-U in FIG. 6. FIG. 7D illustrates a portion indicated by alternate long and short lines arrow V-V in FIG. 6. FIG. 8A is a plan view illustrating a key portion of the jig 1000. Each of FIGS. 8B and 8C is a sectional view illustrating a key portion of the jig 1000. FIG. 8A illustrates a top right-hand end portion of the jig 1000 in FIG. 6. FIG. 8B illustrates a portion indicated by alternate long and short lines arrow S-S in FIG. 6. FIG. 8C illustrates a portion indicated by alternate long and short lines arrow U-U in FIG. 6.

In this regard, the jig 1000 has a longitudinal direction X, a lateral direction Y orthogonal to the longitudinal direction X, and a height direction Z orthogonal to the longitudinal direction X and the lateral direction Y. In the explanations below, these directions may be referred to. In addition, a plain including the longitudinal direction X and the lateral direction Y may be referred to as a reference plane, and in the explanations below, the reference plane may be referred to.

The jig 1000 includes a first linear member group 1G, a second linear member group 2G, the third linear member group 3G, the fourth linear member group 4G, the fifth linear member group 5G, the sixth linear member group 6G, and the seventh linear member group 7G stacked in this order from the bottom to the top in the height direction Z. However, the number of the linear member groups is not limited to 7 and may be increased or decreased from 7.

In the present preferred embodiment, the first linear member group 1G includes seven straight-line-like linear members 1 extending in the longitudinal direction X. The seven linear members 1 are arranged parallel or substantially parallel to each other at an arrangement pitch D. In this regard, the arrangement pitch denotes the distance between the centers of two adjacent linear members arranged separately.

The second linear member group 2G includes seven straight-line-like linear members 2 extending in the lateral direction Y. The seven linear members 2 are arranged parallel or substantially parallel to each other at an arrangement pitch E. In this regard, the distance E may be equal to the distance D or may differ from the distance D.

The third linear member group 3G includes eight straight-line-like linear members 3 extending in the longitudinal direction X. The eight linear members 3 are arranged parallel or substantially parallel to each other at an arrangement pitch D. The linear members 3 of the third linear member group 3G and the linear members 1 of the first linear member group 1G are arranged so that the distance between the linear member 1 and the linear member 3 is uniform at all places when viewed in the height direction Z. In this regard, in the plan view in FIG. 6, the linear members 3 of the third linear member group 3G are not seen due do to being arranged just below the linear members 7 of the seventh linear member group 7G described later.

The fourth linear member group 4G includes eight straight-line-like linear members 4 extending in the lateral direction Y. The eight linear members 4 are arranged parallel or substantially parallel to each other at an arrangement pitch E. The linear members 4 of the fourth linear member group 4G and the linear members 2 of the second linear member group 2G are arranged so that the distance between the linear member 2 and the linear member 4 is uniform at all places when viewed in the height direction Z. In this regard, in the plan view in FIG. 6, the linear members 4 of the fourth linear member group 4G are not seen due do to being arranged just below the linear members 6 of the sixth linear member group 6G described later.

The fifth linear member group 5G includes eight straight-line-like linear members 5 extending in the longitudinal direction X. The eight linear members 5 are arranged parallel or substantially parallel to each other at an arrangement pitch D. The linear members 5 of the fifth linear member group 5G are arranged just above the respective linear members 3 of the third linear member group 3G. In this regard, in the plan view in FIG. 6, the linear members 5 of the fifth linear member group 5G are not seen due do to being arranged just below the linear members 7 of the seventh linear member group 7G described later.

The sixth linear member group 6G includes eight straight-line-like linear members 6 extending in the lateral direction Y. The eight linear members 6 are arranged parallel or substantially parallel to each other at an arrangement pitch E. The linear members 6 of the sixth linear member group 6G are arranged just above the respective linear members 4 of the fourth linear member group 4G.

The seventh linear member group 7G includes eight straight-line-like linear members 7 extending in the longitudinal direction X. The eight linear members 7 are arranged parallel or substantially parallel to each other at an arrangement pitch D. The linear members 7 of the seventh linear member group 7G are arranged just above the respective linear members 5 of the fifth linear member group 5G.

The number of each of the linear members 1 to 7 is optional and may be independently increased or decreased.

In the present preferred embodiment, the linear members 1, 3, 5, and 7 are orthogonal to the linear members 2, 4, and 6. That is, the intersection angle is about 90°, for example. However, the intersection angle of the linear members 1, 3, 5, and 7 and the linear members 2, 4, and 6 is not limited to about 90° and may be increased or decreased from about 90°.

In the present preferred embodiment, members having a circular cross-sectional shape with the same area and the same diameter are used as the linear members 1 to 7. However, the shape, the area, the diameter, and the like of the cross section of the linear members 1 to 7 are optional and may be freely selected. In this regard, the shape, the area, the diameter, and the like of the cross section of the linear members 1 to 7 may differ on a linear member basis.

In the present preferred embodiment, ceramic preferably is used as the material (raw material) for forming the linear members 1 to 7. Regarding the ceramic, for example, SiC, zirconia, yttria-stabilized zirconia, alumina, and mullite may be used. However, the material for forming the linear members 1 to 7 is optional, and metals, such as nickel, aluminum, Inconel (registered trademark), and SUS, resin materials, such as polytetrafluoroethylenes (PTFE), polypropylenes (PP), acrylic resins, ABS (acrylonitrile butadiene styrene)-like resins, and other heat-resistant resins, composite materials including carbon or metal and ceramic, and the like may be used instead of the ceramic.

The surfaces of the linear members 1 to 7 may be further coated with ceramic, such as SiC, zirconia, yttria-stabilized zirconia, alumina, or mullite, or a metal such as nickel.

The jig 1000 may be produced by, for example, wet-mixing and molding a ceramic powder, a binder resin, a solvent, and the like so as to produce an unfired ceramic linear member, producing an unfired structure by using the resulting unfired ceramic linear member, and firing the resulting structure.

The jig 1000 having the above-described configuration includes a plurality of chip storing portions 8. The chip storing portion 8 has an opening 8a in the upper section. The chip storing portion 8 is configured to store a ceramic chip element assembly.

The plurality of chip storing portions 8 are regularly formed in the jig 1000. In the present preferred embodiment, the plurality of chip storing portions 8 are formed in a matrix (in a lattice pattern of uniform squares) on the main surface of the jig 1000. However, the arrangement of the chip storing portions 8 is not limited to the matrix.

Each chip storing portion 8 has a bottom portion 8b to support the ceramic chip element assembly from below and a side wall portion 8c opened due to the opening 8a. In the present preferred embodiment, a chip storing portion 8 includes a bottom portion 8b and four side wall portions 8c. However, the number of the side wall portions 8c is not limited to 4 and may be increased or decreased from 4.

The chip storing portion 8 stores the ceramic chip element assembly without restriction.

As illustrated in FIG. 8A, the bottom portion 8b of the chip storing portion 8 is including a top surface (ridge lines) of the linear members 2. The bottom portion 8b has a bottom portion through hole 8d that is including a gap between two mutually adjacent linear members 2 and that is in communication with the back surface of the bottom portion 8b.

As illustrated in FIGS. 8B and 8C, the side wall portion 8c of the chip storing portion 8 is formed from the linear members 4 and 6 or the linear members 3, 5, and 7. The side wall portion 8c has a side wall portion through hole 8e in communication with an adjacent another chip storing portion 8 in a gap between the linear member 4 and the linear member 6, a gap between the linear member 3 and the linear member 5, a gap between the linear member 5 and the linear member 7, or the like.

### Feature 1 of Jig 1000

Using the jig 1000 having the above-described structure enables the ceramic chip element assembly working step to be performed while the ceramic chip element assemblies are in the state of being independently stored in the chip storing portions 8 in a one-to-one correspondence and, therefore, enables variations in the working condition between the ceramic chip element assemblies to be decreased. Consequently, regarding the ceramic electronic component produced by using the jig 1000, variations in the quality (characteristics, shape, and the like) are reduced or prevented from occurring.

In addition, when the jig 1000 is used, since the ceramic chip element assemblies do not come into contact with each other during the ceramic chip element assembly working step (for example, firing step), the ceramic chip element assemblies subjected to the ceramic chip element assembly working step do not readily adhere to each other. Even when the ceramic chip element assemblies are fragile, breakage due to collision with each other does not readily occur. Therefore, using the jig 1000 enables the defective rate of the ceramic electronic component to be decreased.

Using the jig 1000 enables the ceramic electronic component to be produced with high productivity since the ceramic chip element assembly can be readily stored in the chip storing portion 8 in a short time.

When ceramic is used as the material (raw material) for forming the jig 1000, since the heat resistance is high compared with other materials, the jig 1000 can be reduced or prevented from being broken or deformed even when the working step is the synthesis step, the firing step, or the like which is accompanied by heating. In addition, the material for forming the jig 1000 being ceramic enables the attention to the synthesis atmosphere and the firing atmosphere to be decreased. For example, when the material for forming the jig 1000 is nickel, there is a concern that oxygen in the atmosphere may be absorbed so as to change the atmosphere, but when the material for forming the jig 1000 is ceramic, such a problem does not readily occur. The material for forming the jig 1000 being ceramic enables attention to a reaction with the ceramic chip element assembly to be decreased. For example, when the material for forming the jig 1000 is iron, there is a concern that the reaction with the ceramic chip element assembly may occur, but when the material for forming the jig 1000 is ceramic, such a problem does not readily occur.

Since the linear members 1 to 7 have a substantially straight-line shape and have no bent portion, the jig 1000 is resistant to physical shock. In addition, even when stress is applied due to a temperature change, breakage does not readily occur. Therefore, the jig 1000 is not readily broken even when a material such as ceramic sensitive to a shock is used.

### Feature 2 of Jig 1000

To produce the ceramic electronic component with high productivity, in the ceramic chip element assembly working step such as the firing step, a plurality of jigs storing the ceramic chip element assembly may be used while being stacked on top of each other in a plurality of stages. However, the jig in the related art has a problem that the breathability of the storing portion deteriorates when used while being stacked on top of each other in a plurality of stages.

On the other hand, regarding the jig 1000, in addition to the opening 8a formed in the upper section of the chip storing portion 8, the side wall portion through hole 8e is formed in the side wall portion 8c, and the bottom portion through hole 8d is formed in the bottom portion 8b. In this regard, it is desirable that the side wall portion through hole 8e and the bottom portion through hole 8d have a size and a shape through which the ceramic chip element assembly cannot pass.

The jig 1000 is provided with, in addition to the opening 8a, the side wall portion through hole 8e and the bottom portion through hole 8d through which gas can pass and, therefore, has favorable breathability. Consequently, using the jig 1000 enables defective working due to poor breathability to be reduced or prevented from occurring.

### Regarding Dimension of Chip Storing Portion 8 of Jig 1000

The jig 1000 is designed, provided that a chip storing portion 8 stores a ceramic chip element assembly. In the present preferred embodiment, it is assumed that the rectangular or substantially rectangular parallelepiped ceramic chip element assembly in a state of standing (in a state in which the long side of the ceramic chip element assembly is set to be parallel to the height direction Z) is stored in the chip storing portion 8.

The factors in the present preferred embodiment will be described in further detail. The dimension of the chip storing portion 8 requires room so that the ceramic chip element assembly is readily stored. However, the dimension of the chip storing portion 8 must not allow the ceramic chip element assembly in a state of lying to be stored. The dimension of the chip storing portion 8 must not allow two or more ceramic chip element assemblies in a state of standing to be stored side by side. The dimension of the chip storing portion 8 must not allow the ceramic chip element assembly once stored in the chip storing portion 8 to readily jump outside due to application of vibration. The dimension of the chip storing portion 8 must not allow two or more ceramic chip element assemblies in a state of standing to be stored while being stacked on top of each other.

To satisfy the above-described factors, it is preferable that the dimension of the chip storing portion 8 satisfy Formula (1) below, where the diameter dimension of an inscribed circle of the side wall portion 8c of the chip storing portion 8 when viewed from above in the height direction illustrated in FIG. 9A is denoted by P, and the depth dimension specified by the dimension from the bottom portion 8b of the chip storing portion 8 to the opening 8a when viewed in the side surface direction orthogonal to the height direction illustrated in FIG. 9B is denoted by Q.

(P/2)<Q<(3√/2/2)P (1)

The reason the dimension of the chip storing portion 8 preferably satisfy Formula (1) will be described below. In this regard, the dimension of the ceramic chip element assembly stored in the chip storing portion 8 is assumed that when the width dimension is a, the thickness dimension is a, and the length dimension is 2a, which is based on a shape adopted by many ceramic electronic components.

The dimension of the chip storing portion 8 requires room so that the ceramic chip element assembly is readily stored, and when the ceramic chip element assembly, in a state of standing, stored in the chip storing portion 8 can be rotated in the circumferential direction in the chip storing portion 8, it can be said that the dimension having room. Consequently, Formula (2) below has to be satisfied. Formula (2) specifies that (√2)a which is a dimension of the diagonal of the ceramic chip element assembly when viewed in the height direction is smaller than the diameter dimension P of the inscribed circle and specifies that the ceramic chip element assembly can be rotated in the chip storing portion 8.

(√2)a<P (2)

The dimension of the chip storing portion 8 must not allow a ceramic chip element assembly in a state of lying to be stored. In addition, the dimension of the chip storing portion 8 must not allow two or more ceramic chip element assemblies in a state of standing to be stored side by side. Consequently, it is sufficient that 2a which is a dimension twice the width dimension a, which is a dimension twice the thickness dimension a, and which is also a length dimension is larger than the diameter dimension P of the inscribed circle. That is, it is sufficient that Formula (3) below is satisfied.

P<2a (3)

The dimension of the chip storing portion 8 must not allow the ceramic chip element assembly once appropriately stored in the chip storing portion 8 to readily jump outside due to application of vibration. Consequently, it is sufficient that the depth Q of the chip storing portion 8 is larger than about 0.5 times (half) the length dimension 2a of the ceramic chip element assembly. That is, it is sufficient that 2a×0.5<Q applies, and it is sufficient that Formula (4) below is satisfied.

a<Q (4)

Not to allow two or more ceramic chip element assemblies in a state of standing to be stored in the chip storing portion 8 while being stacked on top of each other, it is sufficient that the depth Q of the chip storing portion 8 is smaller than about 1.5 times the length dimension 2a of the ceramic chip element assembly. Even when an unnecessary ceramic chip element assembly is stored on a ceramic chip element assembly, the unnecessary ceramic chip element assembly stored on the ceramic chip element assembly is readily removed outside the chip storing portion 8 by applying vibration, inclining the jig, or inclining the jig while applying vibration. Therefore, it is sufficient that Q<2a×1.5 applies, and it is sufficient that Formula (5) below is satisfied.

Q<3a (5)

(P/2)<a<Q applies from Formula (3) and Formula (4), and Formula (6) below further applies.

(P/2)<Q (6)

In addition, Q<3a<(3√2/2)P applies from Formula (2) and Formula (5), and Formula (7) below further applies.

Q<(3√2/2)P (7)

Consequently, Formula (1) applies by combining Formula (6) and Formula (7).

(P/2)<Q<(3√2/2)P (1)

It is preferable that the jig 1000 satisfy Formula (1), where, regarding the dimension of the chip storing portion 8, the diameter dimension of an inscribed circle of the side wall portion 8c of the chip storing portion 8 when viewed from above in the height direction is denoted by P, and the depth dimension specified by the dimension from the bottom portion 8b of the chip storing portion 8 to the opening 8a when viewed in the side surface direction orthogonal to the height direction is denoted by Q.

When the dimension of the chip storing portion 8 of the jig 1000 satisfies Formula (1), provided that Formula (2) and Formula (3) are satisfied, the chip storing portion 8 has sufficient room to store the ceramic chip element assembly, the ceramic chip element assembly in a state of lying is not stored in the chip storing portion 8, two or more ceramic chip element assemblies in a state of standing are not stored side by side, the ceramic chip element assembly once appropriately stored in the chip storing portion 8 does not readily jump outside due to application of vibration, and further, two or more ceramic chip element assemblies in a state of standing are not stored in the chip storing portion 8 while being stacked on top of each other.

### Modified Example 1 of Jig 1000

In a factory in which a plurality of types of ceramic electronic components are produced and in a factory in which a plurality of products that are the same type of ceramic electronic components but that differ from each other in the size and the like are produced, it may be necessary to provide and use a plurality of types of jigs 1000 that differ from each other in, for example, the size and the shape of the chip storing portion 8.

In such an instance, it is important that the type of the jig 1000 can be readily distinguished. This is because taking a time to select the jig 1000 causes deterioration of the productivity of the ceramic electronic component. In addition, this is because there is a concern that when an incorrect type of jig 1000 is used, defective characteristics and shape of the produced ceramic electronic component may occur. Examples include an instance in which a small ceramic chip element assembly is worked by using the jig 1000 provided with a large chip storing portion 8 and an instance in which a large ceramic chip element assembly is worked by using the jig 1000 provided with a small chip storing portion 8.

Therefore, it is also preferable that a portion of the jig 1000 be provided with a specific feature different from the other portion to enable the type of the jig 1000 to be readily distinguished. The specific feature different from the other portion is, for example, a color. When a portion of the jig 1000 is provided with a color different from the other portion, it is considered that the breathability, the heat resistance, the resistance to a physical shock, and the like of the jig 1000 do not deteriorate, and therefore it is favorable. In this regard, the specific feature different from the other portion is not limited to the color, and the shape of the jig 1000 may be changed, or a member serving as a mark may be added.

A specific example described below is considered. The above-described jig 1000 is including the linear members 1 to 7, and a method in which the color of one type of linear member thereof is differentiated from the color of the other linear members is considered. For example, in the method, the color of the linear member 1 is changed into a red-based color, a blue-based color, a green-based color, or the like on a jig 1000 basis in accordance with the size (for example, large, medium, and small) of the chip storing portion 8. In this regard, the colors of the remainder linear members 2 to 7 of every jig 1000 are set to be different from the color of the linear member 1. According to this method, the type of the jig 1000 is readily distinguished.

In this regard, examples of the method for changing the color of the linear member include a method in which a heat-resistant ink, color zirconia, or the like is added to the material for forming the linear member 1. This method is favorable since, in particular, even when the raw material for the jig 1000 contains ceramic, the heat resistance of the jig 1000 does not deteriorate. In such an instance, it is more preferable that the linear member 1 belonging to the first linear member group 1G be colored. The reason for this is considered to be that since the linear member 1 belonging to the first linear member group 1G does not come into contact with the ceramic chip element assembly stored in the chip storing portion 8, an influence on the ceramic chip element assembly due to coloring can be eliminated or minimized.

Regarding the jig 1000 according to Modified Example 1, the type of the jig is readily distinguished.

### Modified Example 2 of Jig 1000

It is also preferable that the jig 1000 can be divided into a plurality of portions in the height direction Z.

FIGS. 10A and 10B illustrate Modified Example 2 in which the jig 1000 can be divided into a lower portion 1000A and an upper portion 1000B. In this regard, FIG. 10A illustrates a state in which the lower portion 1000A and the upper portion 1000B are divided, and FIG. 10B illustrates a state in which the lower portion 1000A and the upper portion 1000B are united. The lower portion 1000A is formed from the linear members 1 to 5. The upper portion 1000B is formed from the linear members 6 and 7.

The lower portion 1000A includes a lower chip storing portion 8f including a lower side wall portion 8ca. The upper portion 1000B includes an upper chip storing portion 8g including an upper side wall portion 8cb. When the lower portion 1000A and the upper portion 1000B are united, the chip storing portion 8 is including the lower chip storing portion 8f and the upper chip storing portion 8g. In this regard, the side wall portion 8c is including the lower side wall portion 8ca and the upper side wall portion 8cb.

Regarding the jig 1000, in an instance, it is better that the head of the ceramic chip element assembly 200 stored in the chip storing portion 8 protrude from the opening 8a outside the chip storing portion 8, and in another instance, it is better that the head not protrude outside the chip storing portion 8.

For example, when the ceramic chip element assembly 200 is removed from the chip storing portion 8, in general, it is better that the head of the ceramic chip element assembly 200 protrude outside the chip storing portion 8. This is because the ceramic chip element assembly 200 is readily removed with decreasing depth of the chip storing portion 8. In such an instance, the upper portion 1000B of the jig 1000 is removed so that the head of the ceramic chip element assembly 200 can protrude outside the chip storing portion 8. That is, the depth of the chip storing portion 8 can be decreased.

On the other hand, when the ceramic chip element assembly 200 is stored into the chip storing portion 8, in general, it is better that the head of the ceramic chip element assembly 200 not protrude outside the chip storing portion 8. This is because when the head of the ceramic chip element assembly 200 protrudes outside the chip storing portion 8, there is a concern that the ceramic chip element assembly 200 stored in the chip storing portion 8 in advance may hinder another ceramic chip element assembly not yet stored from being stored into another chip storing portion 8. In such an instance, it is possible that the lower portion 1000A and the upper portion 1000B are united and the head of the ceramic chip element assembly 200 does not protrude outside the chip storing portion 8. That is, the depth of the chip storing portion 8 can be increased.

In this regard, since the upper portion 1000B is removed or not removed in order to make the head of the ceramic chip element assembly 200 stored in the chip storing portion 8 protrude or not protrude, it is also preferable that the size of the lower portion 1000A in the height direction be made larger than the size of the upper portion 1000B in the height direction.

The jig 1000 may be divided into three or more portions in the height direction Z.

Regarding the jig 1000 according to Modified Example 2, since the jig 1000 can be divided into a plurality of portions in the height direction Z, the depth of the chip storing portion 8 can be changed.

### Modified Example 3 of Jig 1000

In the jig 1000, it is also preferable that the area surrounded by the side wall portion 8c of the chip storing portion 8 be increased from a lower section toward an upper section. This is because the ceramic chip element assembly is readily stored or removed.

FIG. 11 illustrates Modified Example 3 of the jig 1000 in which the area surrounded by the side wall portion 8c of the chip storing portion 8 is increased from a lower section toward an upper section. In Modified Example 3, the size of the opening of the chip storing portion 8 is increased from a lower section toward an upper section by applying diameter of linear member 1=diameter of linear member 2=diameter of linear member 3<diameter of linear member 4=diameter of linear member 5<diameter of linear member 6=diameter of linear member 7. However, the diameters of the linear members 1 to 7 may be appropriately changed. In this regard, the method for increasing the size of the opening of the chip storing portion 8 from a lower section toward an upper section is not limited to the method in which the size of the diameters of the linear members 1 to 7 are adjusted, and other methods may be adopted.

### Modified Example 4 of Jig 1000

FIGS. 12A and 12B illustrate a jig 1000 according to Modified Example 4. In this regard, each of FIGS. 12A and 12B is a sectional view illustrating a jig 1000.

Regarding the jig 1000 according to the Modified Example 4, the arrangement pitch of the linear member is changed. That is, in the above-described jig 1000, the plurality of linear members 3 extending in the longitudinal direction X are arranged parallel or substantially parallel to each other at an arrangement pitch D in the lateral direction Y. The plurality of linear members 4 extending in the lateral direction Y are arranged parallel or substantially parallel to each other at an arrangement pitch E in the longitudinal direction X. The plurality of linear members 5 extending in the longitudinal direction X are arranged parallel or substantially parallel to each other at an arrangement pitch D in the lateral direction Y. The plurality of linear members 6 extending in the lateral direction Y are arranged parallel or substantially parallel to each other at an arrangement pitch E in the longitudinal direction X. The plurality of linear members 7 extending in the longitudinal direction X are arranged parallel or substantially parallel to each other at an arrangement pitch D in the lateral direction Y. In addition, chip storing portions 8 are formed in a matrix on the entire main surface of the jig 1000.

Regarding Modified Example 4, the above is changed, and regarding the linear members 3, 4, 5, 6, and 7, arrangement pitches, each of which is a distance between separately arranged two adjacent linear members, are made to partly differ from each other. Specifically, regarding the linear members 3, 5, and 7, a large arrangement pitch DB and a small arrangement pitch DS are alternately repeated. Regarding the linear members 4 and 6, a large arrangement pitch EB and a small arrangement pitch ES are alternately repeated. In this regard, to improve the breathability described below, the dimension of the large arrangement pitch DB is preferably about 120% or more of the small arrangement pitch DS. The dimension of the large arrangement pitch EB is preferably about 120% or more of the small arrangement pitch ES.

As a result, the chip storing portion 8 capable of storing the ceramic chip element assembly and a non-chip storing portion 38 unable to store the ceramic chip element assembly are formed on the main surface of the jig 1000 according to Modified Example 4.

When the chip storing portion 8 is formed on the entire main surface of the jig, the breathability may deteriorate due to the stored ceramic chip element assembly. On the other hand, regarding the jig 1000 according to Modified Example 4, the breathability is improved since the non-chip storing portion 38 unable to store the ceramic chip element assembly is disposed.

### Advantage of Method for Manufacturing Ceramic Electronic Component (Multilayer Ceramic Capacitor 100) According to First Preferred Embodiment

In the method for manufacturing a ceramic electronic component according to the present preferred embodiment, the ceramic chip element assembly working step (for example, firing step) is performed in a state in which the ceramic chip element assembly 21 is stored in the chip storing portion 8 of the jig 1000. Therefore, variations in the quality (electrical characteristics, shape, and the like) of the ceramic chip element assembly 11 after working are reduced or prevented from occurring. That is, the ceramic chip element assembly 11 stored and worked in any chip storing portion 8 can have substantially the same quality.

Therefore, according to the method for manufacturing a ceramic electronic component of the present preferred embodiment, variations in the quality of the produced ceramic electronic component (multilayer ceramic capacitor 100) are reduced or prevented from occurring.

According to the method for manufacturing a ceramic electronic component of the present preferred embodiment, the ceramic chip element assemblies 11 subjected to the ceramic chip element assembly working step (for example, firing step) are suppressed from adhering to each other.

According to the method for manufacturing a ceramic electronic component of the present preferred embodiment, in a step such as a degreasing step related to a reaction, a working time (treatment time) may be decreased by using the jig 1000 having high breathability.

Therefore, according to the method for manufacturing a ceramic electronic component of the present preferred embodiment, a ceramic electronic component can be produced at a low defective rate with high productivity.

### Second Preferred Embodiment

Regarding a second preferred embodiment, the jig used in the ceramic chip element assembly working step in the first preferred embodiment is changed. That is, in the first preferred embodiment, the above-described jig 1000 is used, and the ceramic chip element assembly working step (for example, firing step) is performed. In the second preferred embodiment, this is changed, and the ceramic chip element assembly working step is performed by using a jig 2000 illustrated in FIGS. 13A and 13B. In this regard, FIG. 13A is a plan view of the jig 2000. FIG. 13B is a sectional view of the jig 2000 and illustrates a portion indicated by alternate long and short lines arrow R-R in FIG. 13A.

The jig 2000 is rectangular or substantially rectangular when viewed from above in the height direction and has a lower main surface and an upper main surface.

In the jig 2000, a plurality of chip storing portions 28 are formed in a matrix on the upper main surface. The shape of each chip storing portion 28 is rectangular or substantially rectangular when viewed from above in the height direction.

Each chip storing portion 28 is opened upward in the height direction due to the opening 28a. Each chip storing portion 28 has a bottom portion 28b to support the ceramic chip element assembly from below. Each chip storing portion 28 has a side wall portion 28c serving as a partition between adjacent chip storing portions 28. A through hole having a size and a shape through which the ceramic chip element assembly cannot pass may be formed in at least one of the bottom portion 28b and the side wall portion 28c.

The material for forming the jig 2000 is optional and may contain, for example, ceramic as a main component.

The jig 2000 is used, and a multilayer ceramic capacitor 100 (ceramic electronic component) is produced in the method akin to that of the first preferred embodiment.

In the second preferred embodiment in which the jig 2000 is used, the multilayer ceramic capacitor 100 (ceramic electronic component) can be produced while variations in the quality are reduced or prevented from occurring.

Even when the ceramic chip element assembly working step such as the firing step is performed, the ceramic chip element assemblies subjected to the ceramic chip element assembly working step are suppressed from adhering to each other.

The methods for manufacturing a ceramic electronic component according to the first preferred embodiment and the second preferred embodiment are described above. However, the present invention is not limited to the above-described contents, and various modifications may be made within the scope of the invention.

For example, in the above-described preferred embodiments, the multilayer ceramic capacitor is produced as the ceramic electronic component. However, the ceramic electronic component to be produced is not limited to the multilayer ceramic capacitor and may be, for example, multilayer-type ceramic electronic components, such as multilayer ceramic inductors, multilayer ceramic thermistors, multilayer ceramic LC components, and multilayer ceramic substrates, or non-multilayer-type ceramic electronic components, such as ceramic resonators, ceramic filters, ceramic resistors, ceramic thermistors, and ceramic substrates, instead of this.

In the methods for manufacturing a ceramic electronic component according to the preferred embodiments, the ceramic chip element assembly working step includes the firing step. However, the working step is not limited to a synthesis step due to heating. The ceramic chip element assembly working step may be, for example, a synthesis step, a degreasing step, a washing step, a drying step, an outer electrode formation step (paste application, plating, vacuum film formation such as sputtering or vapor deposition, and the like), external shape working step (rounding of edge portion, exposure of end portion of inner electrode, machining, mechanical polishing, sandblast, liquid-phase or gas-phase chemical etching, laser or plasma working, and the like), an annealing step, an aging step, a polarization step, a characteristic-selection step, an appearance-selection step, and an environmental test step (application of stress may be included). In particular, using a jig including ceramic as the raw material is suitable for a step including heating since the heat resistance is high. In this regard, using a jig having a through hole in at least one of the bottom portion and the side wall portion of the chip storing portion is suitable for a step of exposing the ceramic chip element assembly to gas or liquid since the breathability and the liquid-passing performance are high.

A method for manufacturing ceramic electronic component according to a preferred embodiment of the present invention is as described above.

In this method for manufacturing a ceramic electronic component, it is preferable that the ceramic chip element assembly working step include the firing step. In such an instance, a plurality of resulting fired ceramic chip element assemblies do not readily adhere to each other, and a defective product is reduced or prevented from occurring.

It is also preferable that the ceramic chip element assembly storing step include a step of placing the plurality of ceramic chip element assemblies at random positions and in random states on the jig and storing the plurality of ceramic chip element assemblies placed on the jig into the chip storing portions by vibrating the jig and/or inclining the jig. In such an instance, the ceramic chip element assemblies can be readily stored into the chip storing portions in a short time.

It is preferable that the ceramic chip element assembly production step include a mother ceramic green sheet production step of producing a mother ceramic green sheet including a plurality of ceramic green sheets, a mother ceramic green sheet multilayer body production step of producing a mother ceramic green sheet multilayer body by stacking and integrating a plurality of mother ceramic green sheets, and a mother ceramic green sheet multilayer body cutting step of cutting the mother ceramic green sheet multilayer body into individual ceramic chip element assemblies. In such an instance, the multilayer type ceramic electronic component can be produced while variations in the quality (characteristics, shape, and the like) are reduced or prevented from occurring.

It is also preferable that the ceramic chip element assembly production step include an inner electrode paste application step of coating a main surface of a predetermined ceramic green sheet with an inner electrode paste. In such an instance, an inner electrode can be readily formed inside the multilayer type ceramic electronic component.

It is also preferable that an outer electrode paste application step of coating an outer surface of an unfired ceramic chip element assembly with an outer electrode paste be included before the ceramic chip element assembly working step. Alternatively, it is also preferable that the outer electrode paste application step of coating an outer surface of a fired ceramic chip element assembly and an outer electrode paste baking step of baking the outer electrode paste onto the outer surface of the ceramic chip element assembly be included after the ceramic chip element assembly working step. In such an instance, the outer electrode can be readily formed on the outer surface of the ceramic electronic component.

It is also preferable that a plating step of forming at least one plating electrode layer on an outer surface of the outer electrode formed on the outer surface of the ceramic chip element assembly is included. In such an instance, the plating electrode layer can protect the outer electrode and improve the wettability of the outer electrode.

It is also preferable that the jig contain ceramic as a raw material. In such an instance, since the heat resistance is high compared with other materials, the jig can be reduced or prevented from being broken or deformed even when the working step is the synthesis step, the firing step, or the like which is accompanied by heating. In this regard, the material for forming the jig being ceramic enables the attention to the synthesis atmosphere and the firing atmosphere to be decreased. In addition, the attention to the reaction with the ceramic chip element assembly can be decreased.

It is also preferable that the jig be produced from a plurality of linear members. In such an instance, since the linear members have no bent portion, the jig resistant to physical shock can be obtained. In addition, the jig resistant to breakage even when stress is applied due to a temperature change can be obtained.

It is also preferable that the jig have a longitudinal direction, a lateral direction orthogonal to the longitudinal direction, and a height direction orthogonal to the longitudinal direction and the lateral direction, the plurality of linear members belong to any one of a plurality of linear member groups, the plurality of linear member groups be stacked in the height direction, the plurality of linear members belonging to a linear member group be arranged parallel or substantially parallel to and separately from each other, and the linear member belonging to a linear member group stacked as a layer mutually intersect with the linear member belonging to another linear member group stacked as another adjacent layer when viewed in the height direction. In such an instance, since the linear members have substantially straight-line shape and have no bent portion, the jig resistant to physical shock can be obtained. In addition, the jig that is not readily broken even when stress is applied due to a temperature change can be obtained.

It is also preferable that, in the jig, the bottom portion be including at least one linear member belonging to a linear member group, the side wall portion be including a linear member belonging to a linear member group or at least two linear members belonging to at least two linear member groups, respectively, the bottom portion have a bottom portion through hole in communication with a back surface of the bottom portion, the side wall portion have a side wall portion through hole in communication with another adjacent chip storing portion, the bottom portion through hole be including a gap between two linear members adjacent to each other in the linear member group constituting the bottom portion, and the side wall portion through hole be including a gap between linear members of the side wall portion. In such an instance, the jig having favorable breathability can be obtained. Therefore, using the jig enables defective working due to poor breathability to be reduced or prevented from occurring.

It is also preferable that, in at least one linear member group, arrangement pitches, each of which is a distance between separately arranged two adjacent linear members, partly differ from each other. In such an instance, since a non-chip storing portion that does not store the ceramic chip element assembly can be disposed in addition to the chip storing portion, the breathability can be improved.

It is also preferable that the chip storing portions be formed in a matrix on the main surface of the jig. In such an instance, many chip storing portions can be formed in the jig, and a ceramic electronic component can be produced with high productivity.

It is also preferable that the jig can be divided into a plurality of portions in the height direction. In such an instance, in the ceramic chip element assembly storing step, the ceramic chip element assembly working step, the ceramic chip element assembly removal step, or the like, it can be selected whether the head of the ceramic chip element assembly is made to protrude from the chip storing portion or whether the head is not made to protrude, as the situation demands.

It is also preferable that the opening area of the chip storing portion is increased from a lower section toward an upper section. In such an instance, the efficiency of the ceramic chip element assembly storing step or the ceramic chip element assembly removal step is improved.

It is also preferable that Formula (1) below be satisfied, where the diameter dimension of an inscribed circle of the side wall portion of the chip storing portion when viewed from above is denoted by P, and the depth dimension of the chip storing portion is denoted by Q.

(P/2)<Q<(3√/2/2)P (1)

In such an instance, the chip storing portion has sufficient room to store the ceramic chip element assembly, the ceramic chip element assembly in a state of lying is not stored in the chip storing portion, two or more ceramic chip element assemblies in a state of standing are not stored side by side, the ceramic chip element assembly once appropriately stored in the chip storing portion does not readily jump outside due to application of vibration, and further, two or more ceramic chip element assemblies in a state of standing are not stored in the chip storing portion while being stacked on top of each other.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method for manufacturing a ceramic electronic component, the method comprising:
a ceramic chip element assembly production step of producing a plurality of ceramic chip element assemblies;
a jig preparation step of preparing a jig provided with a plurality of chip storing portions including a bottom portion to support a ceramic chip element assembly from below and an open-top side wall portion;
a ceramic chip element assembly storing step of storing the ceramic chip element assemblies into the chip storing portions of the jig in a one-to-one correspondence;
a ceramic chip element assembly working step of working the ceramic chip element assemblies stored in the chip storing portions of the jig; and
a ceramic chip element assembly removal step of removing the ceramic chip element assemblies from the chip storing portions of the jig.

2. The method for manufacturing a ceramic electronic component according to claim 1, wherein the ceramic chip element assembly working step includes a firing step.

3. The method for manufacturing a ceramic electronic component according to claim 1, wherein
the ceramic chip element assembly storing step include:
placing the plurality of ceramic chip element assemblies at random positions and in random states on the jig; and
storing the plurality of ceramic chip element assemblies placed on the jig into the chip storing portions by vibrating the jig and/or inclining the jig.

4. The method for manufacturing a ceramic electronic component according to claim 1, wherein
the ceramic chip element assembly production step includes:
a mother ceramic green sheet production step of producing a mother ceramic green sheet including a plurality of ceramic green sheets;
a mother ceramic green sheet multilayer body production step of producing a mother ceramic green sheet multilayer body by stacking and integrating a plurality of mother ceramic green sheets; and
a mother ceramic green sheet multilayer body cutting step of cutting the mother ceramic green sheet multilayer body into individual ceramic chip element assemblies.

5. The method for manufacturing a ceramic electronic component according to claim 4, wherein the ceramic chip element assembly production step includes an inner electrode paste application step of coating a main surface of the predetermined ceramic green sheet with an inner electrode paste.

6. The method for manufacturing a ceramic electronic component according to claim 1, wherein an outer electrode paste application step of coating an outer surface of the unfired ceramic chip element assembly with an outer electrode paste is included before the ceramic chip element assembly working step.

7. The method for manufacturing a ceramic electronic component according to claim 1, wherein an outer electrode paste application step of coating an outer surface of the fired ceramic chip element assembly and an outer electrode paste baking step of baking the outer electrode paste onto the outer surface of the ceramic chip element assembly are included after the ceramic chip element assembly working step.

8. The method for manufacturing a ceramic electronic component according to claim 6, wherein a plating step of forming at least one plating electrode layer on an outer surface of the outer electrode formed on the outer surface of the ceramic chip element assembly is included.

9. The method for manufacturing a ceramic electronic component according to claim 7, wherein a plating step of forming at least one plating electrode layer on an outer surface of the outer electrode formed on the outer surface of the ceramic chip element assembly is included.

10. The method for manufacturing a ceramic electronic component according to claim 1, wherein the jig includes ceramic as a raw material.

11. The method for manufacturing a ceramic electronic component according to claim 1, wherein the jig is produced from a plurality of linear bodies.

12. The method for manufacturing a ceramic electronic component according to claim 11, wherein
the jig has a longitudinal direction, a lateral direction orthogonal to the longitudinal direction, and a height direction orthogonal to the longitudinal direction and the lateral direction;
the plurality of linear bodies belong to any one of a plurality of linear body groups;
the plurality of linear body groups are stacked in the height direction;
the plurality of linear bodies belonging to a linear body group are arranged parallel or substantially parallel to and separately from each other; and
the linear body belonging to a linear body group stacked as a layer mutually intersects with the linear body belonging to another linear body group stacked as another adjacent layer when viewed in the height direction.

13. The method for manufacturing a ceramic electronic component according to claim 12, wherein, in the jig:
the bottom portion includes at least one linear body belonging to a linear body group;
the side wall portion includes a linear body belonging to a linear body group or at least two linear bodies belonging to at least two linear body groups, respectively;
the bottom portion includes a bottom portion through hole in communication with a back surface of the bottom portion;
the side wall portion includes a side wall portion through hole in communication with another adjacent chip storing portion;
the bottom portion through hole includes a gap between two linear bodies adjacent to each other in the linear body group of the bottom portion; and
the side wall portion through hole includes a gap between linear bodies of the side wall portion.

14. The method for manufacturing a ceramic electronic component according to claim 11, wherein in at least one linear body group, arrangement pitches, each of which is a distance between separately arranged two adjacent linear bodies, partly differ from each other.

15. The method for manufacturing a ceramic electronic component according to claim 1, wherein in the jig, the chip storing portions are formed in a matrix on the main surface of the jig.

16. The method for manufacturing a ceramic electronic component according to claim 1, wherein the jig is divisible into a plurality of portions in the height direction.

17. The method for manufacturing a ceramic electronic component according to claim 1, wherein an area surrounded by the side wall portion of the chip storing portion increases from a lower section toward an upper section of the jig.

18. The method for manufacturing a ceramic electronic component according to claim 1, wherein Formula (1) is satisfied, where a diameter of an inscribed circle of the side wall portion of the chip storing portion when viewed from above is denoted by P, and a depth of the chip storing portion is denoted by Q:
(P/2)<Q<(3√2/2)P (1).

19. The method for manufacturing a ceramic electronic component according to claim 1, wherein the ceramic electronic component is a multilayer ceramic capacitor.

20. The method for manufacturing a ceramic electronic component according to claim 1, wherein the ceramic electronic component is a multilayer ceramic inductor, a multilayer ceramic thermistor, a multilayer ceramic LC component, a multilayer ceramic substrate, a ceramic resonator, a ceramic filter, a ceramic resistor, a ceramic thermistor, or a ceramic substrate.
